(19) United States
(12) Patent Application Publication
(10) Pub. No.: US 2015/0162144 A1
(43) Pub. Date: Jun. 11, 2015

(54) LOAD TAP CHANGER

(71) Applicant: General Electric Company, Schenectady, NY (US)

(72) Inventors: Ara Panosyan, Munich (DE); Eva-Maria Baerthlein, Hamburg (DE); Simon Schramm, Moosach (DE); Stefan Schroeder, Munich (DE); Malcolm Graham Smith, JR., Haughton, LA (US); Piniwan Thiwanka Bandara Wijekoon, Munich (DE)

(73) Assignee: General Electric Company, Schenectady, NY (US)

(21) Appl. No.: 14/099,155

(22) Filed: Dec. 6, 2013

(51) Int. Cl. H01H 9/00

(52) U.S. Cl. CPC H01H 9/0011; H01H 9/0016

(57) ABSTRACT

A method of switching taps by an on-load tap changer includes providing at least two fingers each comprising an impedance and a mechanical switch. When first and second mechanical switches of the first and second fingers are closed, they provide a connection between the first and second impedances of the first and second fingers and a power terminal of the on-load tap changer. The on-load tap changer is triggered to shift at least one of the fingers from a first tap to a second tap of the on-load tap changer when a tap change signal is received. A solid state switch connected between the first and second impedances is switched on to commutate a current from the first finger to the second finger during the tap change operation.

### BACKGROUND

Embodiments of the system relate generally to a field of voltage regulation and more specifically to a load tap changer for power delivery.

Conventionally, electricity is generated in large-scale power plants that are connected to a transmission grid through step up transformers. Electrical power is transmitted over a transmission system over long distances at very high voltages. At distribution substations the voltage is stepped down and power is supplied to different loads within a distribution grid. Voltage regulation in the distribution grid is typically achieved either through On-Load Tap Changing (OLTC) transformers or voltage regulators. Capacitor banks are also widely used in many utilities to support the voltage in distribution grids, where voltage variations are mainly caused by slow variation of loads connected to the distribution system. The increasing share of intermittent and highly variable renewable energy generation connected at distribution level leads to larger and more frequent voltage fluctuations in distribution grids, which requires more flexibility in network voltage regulation. As a consequence, on-load tap changers in distribution grids with large amount of renewable energy generation are being utilized more intensively and extensively.

On-load tap changers have been widely used for power transformers and voltage regulators for many years. Several types of on-load tap changers, both mechanical and electronic, are available in the market. Mechanical on-load tap changers allow for in-service operation, but have demanding mechanical requirements. Each tap changing operation of mechanical tap changers leads to a certain amount of arcing between tap contacts and moving finger contacts. Arcing leads to slow deterioration of the transformer oil and the wear of the mechanical contacts. The lifetime of a mechanical tap changer is hence limited by the number of tap changing operations. Conventional on-load tap changers have nevertheless relatively long lifetime of 15-20 years. This is mainly due to the relatively low number of tap changing operations required to regulate the voltage variations due to load variations. However, due to larger and faster voltage fluctuations in distribution networks caused by the increasing share of distributed renewable energy sources, on-load tap changers are required to switch much more often than before. This leads to much higher maintenance requirements and limited lifetime.

The main drawback of mechanical on-load tap changers is unavoidable arcing between the tap contacts and the moving finger contacts when a tap is changed. Purely electronic on-load tap changers on the other hand do not have any moving finger contacts. Each tap contact is connected to the load through a solid-state electronic switch. The tap position is selected by switching on the corresponding electronic switch (i.e. conducting), while all other switches are switched off (i.e. not conducting). Changing from one tap position to the other is carried out by commutating the current from one electronic switch to the next. The current commutation and tap change is therefore achieved without arcing due to the typically very fast switching capabilities of solid-state switches. Although electronic on-load tap changers are highly flexible and can operate arc-free and would therefore substantially reduce maintenance requirements as compared to mechanical on-load tap changers, they also have certain disadvantages. The main disadvantage is the cost of electronic switches, also because an electronic switch is required for each tap position, which further increases the cost when large number of taps is needed. The second disadvantage is the higher losses of electronic switches compared to mechanical contacts.

Therefore, there still exists a need for an economically more viable as well as technically reliable and efficient alternative solutions for on-load tap changers.

### BRIEF DESCRIPTION

In accordance with an embodiment of the present technique, a method of switching taps of an on-load tap changer is provided. The method includes providing at least two fingers each comprising an impedance and a mechanical switch. When the first and second mechanical switches of the first and second fingers are closed, they provide a connection between the first and second impedances of the first and second fingers and a power terminal of the on-load tap changer. The method also includes triggering the on-load tap changer to shift at least one of the fingers from a first tap to a second tap of the on-load tap changer when a tap change signal is received; wherein the first finger breaks a contact with the first tap and then makes a contact with the second tap. The method further includes switching on a solid state switch connected between the first and second impedances to commutate a current from the first finger to the second finger during the tap change operation.

In accordance with another embodiment of the present technique, an on-load tap changer is provided. The on-load tap changer includes at least two fingers, at least one of which is triggered to switch from a first tap to a second tap of the on-load tap changer when a tap change signal is received from a controller. Each finger includes an impedance and a mechanical switch. When the first and second mechanical switches of the first and second fingers are switched on they provide a connection between the first and second impedance of the first and second fingers and a power terminal of the on-load tap changer. The on-load tap changer also includes a solid state switch connected between the first and the second impedances of the two fingers and switched to commutate a current from the first finger to the second finger during the tap change operation.

In accordance with yet another embodiment of the present technique, a method of switching taps of an on-load tap changer is provided. The method includes transferring an electric current flowing in a mechanical switch connected between a first impedance and a power terminal of the on-load tap changer to a solid state switch connected between the first impedance and a second impedance. The method also includes diverting the electric current flowing in the solid state switch back to the mechanical switch when the first impedance is moved to a new tap.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of a transformer with a mechanical on-load tap changer;

FIG. 2 is a schematic diagram of a transformer with a hybrid on-load tap changer in accordance with an embodiment of the present system;

FIGS. 3a to 3h are schematic diagrams of various steps in an operation of the hybrid on-load tap changer of FIG. 2 in accordance with an embodiment of the present technique;

FIGS. 4a to 4h are schematic diagrams of various steps in an operation of the hybrid on-load tap changer of FIG. 2 in accordance with an embodiment of the present technique; and

FIG. 5 is a schematic diagram of an alternative embodiment of an hybrid on-load tap changer;

### DETAILED DESCRIPTION

As used herein, the terms “controller” or “module” refers to software, hardware, or firmware, or any combination of these, or any system, process, or functionality that performs or facilitates the processes described herein.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The invention includes embodiments that relate to an on-load tap changer utilized for voltage regulation by changing connections from one tap to another of a voltage conversion device. Though the present discussion provides examples in the context of the on-load tap changer for a transformer, these load tap changers can be applied to any other voltage conversion or regulation device utilizing taps.

FIG. 1 shows a schematic diagram 10 of a transformer 11 with a selector switch type mechanical on-load tap changer 18. Transformer 11 is one type of a voltage conversion device which converts a voltage from one level to another level and includes a primary winding 12 and a secondary winding 16 with a plurality of taps 14. In one embodiment, taps 14 may be provided on primary winding 12 or secondary winding 16 or both on primary winding 12 as well as secondary winding 16. In one embodiment, secondary winding 16 provides an output voltage Vo at a reduced level compared to an input voltage Vin of transformer 11. It should be noted that the magnitude and frequency of voltage variations at each point in the distribution grid may vary significantly depending on a number of factors, like the variation of loads and generation, electrical distance from the substation, type of electrical lines and voltage conditions on the high voltage side of the substation. On-load tap changing transformers and voltage regulators are therefore used to compensate for these voltage variations by changing their output voltage Vo.

When the voltage is above or below certain voltage set points a controller (not shown) activates a tap change operation to move finger contacts of on-load tap changer 18 to the next lower or higher tap. In general, transformer output voltage Vo is given as:

Vo=Vin*(T2/T1) (1)

where T2 are secondary winding turns and T1 are primary winding turns. The tap position 14 on secondary winding 16 decides the number of turns T2. Thus, if output voltage Vo needs to be increased, taps 14 are changed such that winding turns T2 will increase. Similarly, when output voltage Vo needs to be decreased, taps 14 are changed appropriately to decrease turns T2.

Mechanical on-load tap changer 18 which includes three finger contacts including a mechanical switch 20 and two switching resistors 22 is utilized to change taps 14 from one position to another position. For changing the taps from one position to another, mechanical on-load tap changer 18 utilizes a drive system (not shown) and rotates mechanical switch 20 and switching resistors 22 in anticlockwise or clockwise direction depending on the voltage change requirement. During the movement, at start one of the switching resistors 22 makes contact with the next tap while mechanical switch 20 is still in contact with the present tap. Then mechanical switch 20 is open circuited i.e., mechanical switch 20 is not connected to any tap, whereas the second switching resistor 22 makes connection with the present tap. This results in short circuit between two taps 14 through two switching resistors 22. Finally, mechanical switch 20 contacts the next tap and then both switching resistors 22 are open circuited completing the tap change operation. The complete tap change operation results in significant energy losses in switching resistors 22 and also related heat generation and maintenance issues.

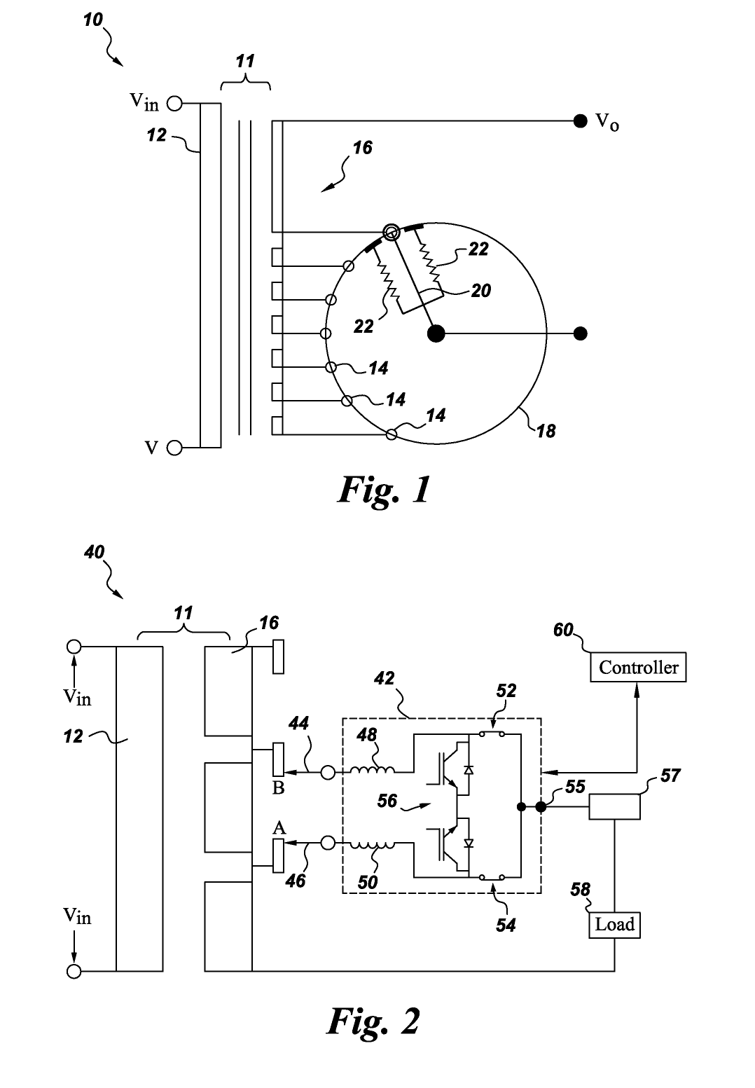

FIG. 2 shows a schematic diagram 40 of transformer 11 with a hybrid on-load tap changer 42 in accordance with an embodiment of the present invention. The hybrid on-load tap changer may also be referred to as electronically assisted or solid state assisted on-load tap changer. Hybrid on-load tap changer 42 includes two fingers 44, 46 each comprising an impedance 48, 50 and a mechanical switch or contactor 52, 54 connected in series. In one embodiment, impedance 48 or 50 may be an inductor or a combination of an inductor and a resistor. Both mechanical switches 52, 54 are connected to a power terminal 55 on one end to carry an electric current and provide a connection between impedances 48, 50 and power terminal 55. The term “power terminal” refers to an output terminal or an input terminal of the tap changer depending on the current flow. Fingers 44, 46 may be connected to transformer taps via a rotary or linear switch. A solid state switch 56 is connected between the two impedances of the two fingers to commutate a current from the first finger to the second finger during the tap change operation. Solid state switch 56 may be an unidirectional switch or a bidirectional solid state switch i.e., a switch which allows passage of current in either direction. In one embodiment, a bidirectional switch may comprise two unidirectional switches. A load 58 shown for representative purposes is connected to power terminal 55 via a wire or a cable 57.

In one embodiment, solid state switch 56 is a bidirectional solid state switch i.e., a switch which allows passage of current in either direction. Examples of the unidirectional solid state switch include a thyristor and a gate turn off thyristor (GTOs), whereas examples of the bidirectional solid state switch include a thyristor pair connected in antiparallel configuration and a triode for alternating current (TRIAC). In one embodiment, when solid state switch 56 is an unidirectional solid state switch, it can be turned ON during a forward bias condition. As will be appreciated by those skilled in the art the forward bias condition occurs when an anode of the unidirectional solid state switch is connected to a positive voltage and a cathode of the unidirectional solid state switch is connected to a negative voltage. When solid state switch 56 is a bidirectional solid state switch, it can be turned ON in any half cycle of the AC voltage.

In one embodiment, a controller 60 is utilized to control the operation of hybrid on-load tap changer 42. Controller 60 triggers the rotary or linear switch to move fingers 44, 46 to from a one tap to another tap when a tap change signal is received. The tap change signal may be received from another controller or may be generated by controller 60 based on measured electrical parameters and/or certain voltage limits at the transformer input or output, or at other points in the grid. Controller 60 further controls the mechanical switches 52, 54, as well as solid state switch 56.

During steady state, fingers 44, 46 are either both connected to the same tap of the transformer, which is a non-bridging position, or each is connected to an adjacent tap, which is a bridging position. During bridging position both fingers 44, 46 are connected to two adjacent transformer taps via impedances 48, 50 to prevent short circuiting the tap winding and limit the circulating current between the two taps. The bridging position is therefore a service position, and each voltage step change is half the voltage between adjacent taps. Furthermore, during normal operation both mechanical switches 52, 54 are conducting or switched on and solid state switch 56 is not conducting or switched off. The current then flows from the transformer tap to power terminal 55 via both impedances 48, 50 and both mechanical switches 52, 54. When the tap change signal is received, hybrid on-load tap changer 42 goes from non-bridging position to a bridging position, or vice versa. In case the bridging position is not required as a service position, the bridging position could only serve as a short transition position. In such an embodiment, each tap change signal leads to going from a non-bridging position to another non-bridging position.

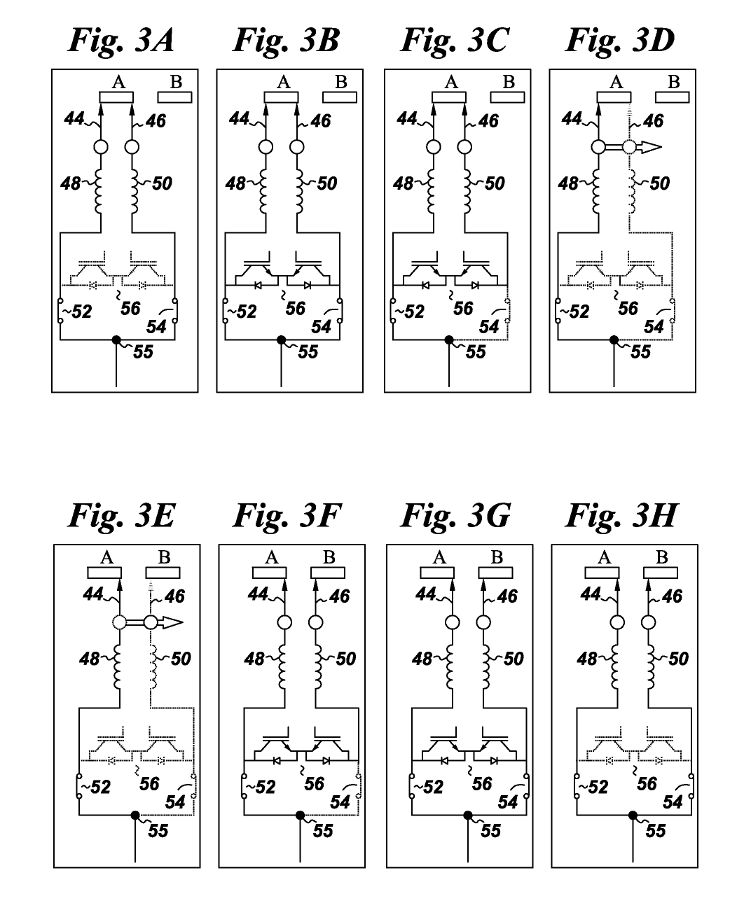

FIGS. 3a to 3h shows a schematic diagram of various steps in an operation of hybrid on-load tap changer 42 of FIG. 2 in accordance with an embodiment of the present invention. It should be noted that for ease of illustration only taps A and B instead of all taps of hybrid tap changer 42 are shown in FIGS. 3a to 3h. In other embodiments, secondary winding 16 (FIG. 2) may be of any other transformer such as a three phase transformer which is connected to the power grid and the load is then a plurality of energy consumption devices. FIGS. 3a to 3h specifically show the transition from a non-bridging position at tap A (FIG. 3a) to a bridging position between tap A and tap B (FIG. 3h). In step 1 (FIG. 3a), a tap change command is set by either a system operator or a controller. In this step, just before the tap change command is received, hybrid tap changer 42 is in a non-bridging position i.e., both fingers 44, 46 are connected to tap A, both mechanical switches 52 and 54 are switched on and are conducting. The solid state switch 56 is switched off and hence is not conducting. This state provides two separate current paths for the load 58 (FIG. 2). The first path is via impedance 48 and mechanical switch 52, and the second path is via impedance 50 and mechanical switch 54. Each path carries about 50% of the load current if both impedances 48, 50 have similar parameters and mechanical switches 52 and 54 have similar contact resistance values.

In step 2 (FIG. 3b), after the tap change command is received, solid state switch 56 is switched on. The load current is further shared between the two previously mentioned current paths, while the solid state switch carries little to no current. In step 3 (FIG. 3c), mechanical switch 54 is switched off and thus stops conducting. This facilitates arc free transition of current from mechanical switch 54 to solid state switch 56. It should be noted that the fingers 44, 46 could start moving from tap A to tap B during this operation. In one embodiment, the mechanism to mechanically move fingers 44, 46 from tap A to tap B may be a rotary mechanism as in FIG. 1

In step 4 (FIG. 3d), solid state switch 56 is switched off before finger 46 starts breaking a connection with tap A. The entire current is therewith diverted to the path via impedance 48 and mechanical switch 52. Finger 46 now breaks the connection with tap A at zero current and therefore without any arcing. Similarly, in step 5 (FIG. 3e) finger 46 makes a connection with tap B without arcing. FIG. 3f shows step 6 where fingers 44 and 46 arrive at a bridging position between taps A and B respectively. In this step, mechanical switch 54 is still switched off and solid state switch 56 is switched on to provide a path for a current from impedance 50 to mechanical switch 52. In step 7 (FIG. 3g), mechanical switch 54 is switched on and in step 8 (FIG. 3h), solid state switch 56 is switched off, thus, completing transition from the non-bridging state at tap A to the bridging state between taps A and B. During the bridging state, there is a circulating current between taps A and B which is limited by impedances 48,50.

In one embodiment, the disconnection instance of solid state switch 56 is based on a zero crossing or a near zero crossing of a current waveform passing through impedance 50 so as to reduce the voltage stress on solid state switch 56. In one embodiment, controller 60 utilizes a mechanism to detect when solid state switch 56 is in a correct mode for commuting the current and send gate signals accordingly.

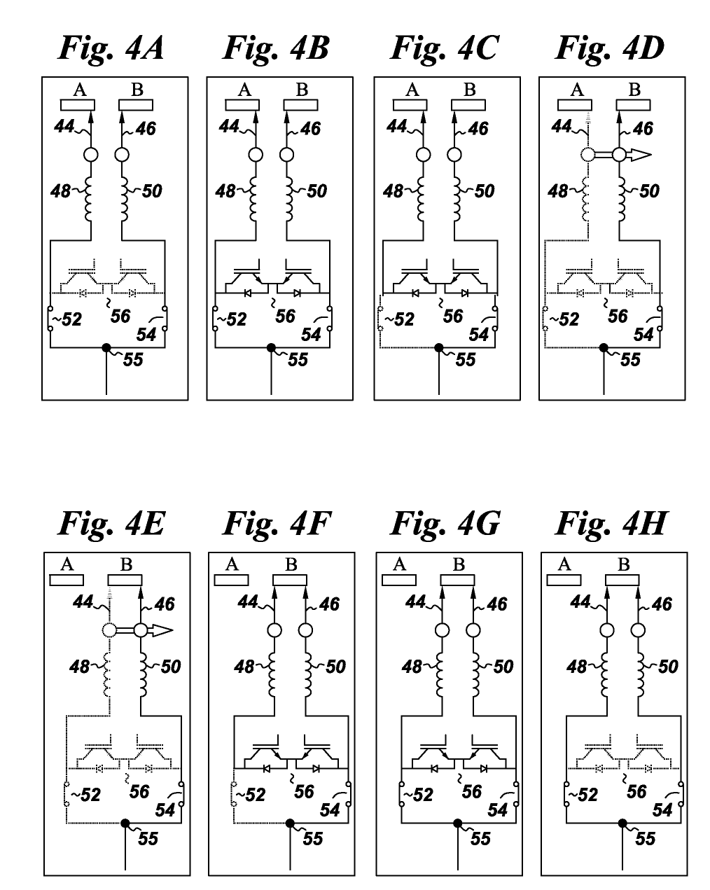

FIGS. 4a to 4h show schematic diagrams of various steps in an operation of hybrid on-load tap changer 42 of FIG. 2, in accordance with an embodiment of the present invention. FIGS. 4a to 4h specifically show transition from a bridging position between tap A and tap B (FIG. 4a) to a non-bridging position at tap B (FIG. 4h). Hybrid on-load tap changer 42 of FIG. 2 is shown in FIG. 4a at a bridging position between tap A and tap B, i.e., fingers 44 and 46 are connected to tap A and B respectively. Both mechanical switches 52 and 54 are switched on and are conducting. The solid state switch 56 is switched off and is not conducting. In step 1 (FIG. 4a), a tap change command is set by either a system operator or a controller 60. In step 2 (FIG. 4b), after the tap change command is received, solid state switch 56 is switched on. In step 3 (FIG. 4c), mechanical switch 52 is switched off. Solid state switch 56 then provides a path for a load current from impedance 48 to mechanical switch 54 and an arc free transition of current from the mechanical switch 52 to solid state switch 56 is achieved

In step 4 (FIG. 4d), solid state switch 56 is switched off before finger 44 starts breaking a connection with tap A. After solid state switch 56 is switched off the entire current is diverted to the path via impedance 50 and mechanical switch 54. Finger 44 now breaks the connection with tap A at about zero current and therefore without any arcing. Likewise in step 5 (FIG. 4e), finger 44 makes a connection with tap B without arcing. FIG. 4f shows step 6 where hybrid on-load tap changer is in a non-bridging position i.e., both fingers 44, 46 are connected to tap B. In this step, mechanical switch 52 is still switched off and solid state switch 56 is switched on to provide a path for a current from impedance 48 to mechanical switch 54. In step 7 (FIG. 4g), mechanical switch 52 is switched on and in step 8 (FIG. 4h), solid state switch 56 is switched off, thus, completing transition from a bridging state between taps A and B to the non-bridging state on tap B. Thus, FIGS. 3 and 4 show a full tap change operation from tap A to tap B for hybrid on-load tap changer 42.

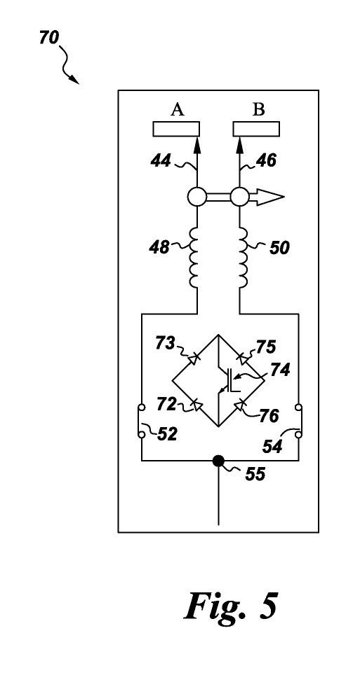

FIG. 5 shows a schematic diagram of another hybrid on-load tap changer 70 in accordance with an embodiment of the present invention. Hybrid on-load tap changer 70 is similar to hybrid on-load tap changer 42 of FIG. 2. However, bidirectional switch 56 of hybrid on-load tap changer 42 is now replaced by a combination of a diode bridge formed by diodes 72, 73, 75, 76 and an unidirectional switch 74. In short, when conducting, the current in unidirectional switch 74 always flows in one direction (e.g., top to bottom) and any one of the left pair of diodes 72, 73 and any one of the right pair of diodes 75, 76 conduct simultaneously to achieve a bidirectional current flow. For example, a current flows from impedance 48 to impedance 50 via diode 73, unidirectional switch 74 and diode 76, whereas a current flow from inductor 50 to inductor 48 via diode 75, unidirectional switch 74 and diode 72.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of switching taps by an on-load tap changer, the method comprising:
providing at least two fingers each comprising an impedance and a mechanical switch, wherein when the first and second mechanical switches of the first and second fingers are closed, they provide a connection between the first and second impedances of the first and second fingers and a power terminal of the on-load tap changer;
triggering the on-load tap changer to shift at least one of the fingers from a first tap to a second tap of the on-load tap changer when a tap change signal is received; wherein the first finger breaks a contact with the first tap and then makes a contact with the second tap;
switching on a solid state switch connected between the first and second impedances to commutate a current from the first finger to the second finger during the tap change operation.

2. The method of claim 1 comprising switching off the first mechanical switch connected to the first impedance after the solid state switch is switched on.

3. The method of claim 2 further comprising switching off the solid state switch before the first finger associated with the first impedance breaks a connection with the first tap.

4. The method of claim 3, wherein the solid state switch is switched on again after the first finger makes a connection with the second tap.

5. The method of claim 4 comprising switching off the solid state switch after the first mechanical switch is switched on.

6. The method of claim 1, wherein the solid state switch comprises a bidirectional switch or an unidirectional switch.

7. The method of claim 6, wherein the bidirectional switch comprises a thyristor pair connected in antiparallel configuration or a triode for alternating current (TRIAC) or a combination of unidirectional switches.

8. The method of claim 6, wherein the bidirectional switch comprises a combination of a unidirectional switch and a diode bridge.

9. An on-load load tap changer comprising:
at least two fingers, at least one of which is triggered to switch from a first tap to a second tap when a tap change signal is received from a controller, each finger including an impedance and a mechanical switch, wherein when the first and second mechanical switches of the first and second fingers are switched on they provide a connection between the first and second impedance of the first and second fingers and a power terminal of the on-load tap changer; and
a solid state switch connected between the first and the second impedances of the two fingers and switched to commutate a current from the first finger to the second finger during the tap change operation.

10. The load tap changer of claim 9, wherein the solid state switch comprises a bidirectional switch or an unidirectional switch.

11. The load tap changer of claim 10, wherein the bidirectional switch comprises a thyristor pair connected in antiparallel configuration or a triode for alternating current (TRIAC) or a combination of unidirectional switches.

12. The load tap changer of claim 10, wherein the bidirectional switch comprises a combination of a unidirectional switch and a diode bridge.

13. The load tap changer of claim 9, wherein the controller is further configured to control the tap change operation steps, the steps comprising:
a) switching off the first mechanical switch connected to the first impedance after the solid state switch is switched on;
b) switching off the solid state switch before the first finger associated with the first impedance breaks a connection with the first tap and switching on the solid state switch after the first finger makes a connection with the second tap; and
c) switching off the solid state switch after the first mechanical switch is switched on.

14. The load tap changer of claim 9 further comprising a rotary mechanism or a linear mechanism to mechanically move the first finger and the second finger from the first tap to the second tap.

15. The load tap changer of claim 9, wherein the controller provides tap change signal based on measured electrical parameters.

16. A method of switching taps by an on-load tap changer, the method comprising:
transferring an electric current flowing in a mechanical switch connected between a first impedance and a power terminal of the on-load tap changer to a solid state switch connected between the first impedance and a second impedance; and
diverting the electric current flowing in the solid state switch back to the mechanical switch when the first impedance is moved to a new tap.

17. The method of claim 16, wherein transferring the electric current flowing in the mechanical switch to the solid state switch comprises switching off the mechanical switch connected to the first impedance after the solid state switch is switched on.

18. The method of claim 16, wherein diverting the electric current flowing in the solid state switch back to the solid state switch comprises switching off the solid state switch before a first finger including a first impedance breaks a connection with the old tap.

19. The method of claim 18 comprising switching on the solid state switch after the first finger makes a connection with the new tap.

20. The method of claim 19 comprising switching off the solid state switch after the mechanical switch is switched on.
